(19) United States
(12) Patent Application Publication
(10) Pub. No.: US 2007/0297883 A1
(43) Pub. Date: Dec. 27, 2007

(54) Bulk material unloading system and method

(76) Inventor: Lloyd Ash, Pleasant Grove, UT (US)

Correspondence Address: THORPE NORTH & WESTERN, LLP., 8180 SOUTH 700 EAST, SUITE 350, SANDY, UT, 84070, US

(21) Appl. No.: 11/809,731

(22) Filed: Jun. 1, 2007

Related U.S. Application Data
(60) Provisional application No. 60/810,496, filed on Jun. 2, 2006.
(60) Provisional application No. 60/810,290, filed on Jun. 2, 2006.

(51) Int. Cl. B65G 67/00

(52) U.S. Cl. 414/339

(57) ABSTRACT

A bulk material unloading station rapidly receives and transfers the contents of a bulk material transport vehicle. The station includes an unloading platform alignable with an existing thoroughfare at an approximate ground level. A frame disposed about the unloading platform defines a material flow control space for controlling the containment and flow rate of material unloaded from the bulk material transport vehicle. A conveyor system operably associated with the material flow control space horizontally moves the lower portion of the bulk material.

### PRIORITY STATEMENT

The present application claims priority to U.S. Provisional Patent application 60/810,496, filed on Jun. 2, 2006; and to U.S. Provisional Patent Application Ser. No. 60/810,290, filed on Jun. 2, 2006, which are incorporated herein by reference in their entirety for all purposes.

### BACKGROUND OF THE INVENTION

1. Field of the Invention

The present invention relates generally to bulk material transportation and more specifically to unloading bulk material from belly dump hopper cars, such as hopper rail cars and hopper dumpster trucks.

2. Related Art

Bulk material, such as coal, mineral ore, gravel, and the like, is often transported in large hoppers on railcars or trucks. These hopper type vehicles are very efficient since they can be loaded and unloaded quickly, and can transport very large quantities of bulk material. However, while these vehicles can usually dump the material relatively quickly, moving the material away from the dump site is generally a much slower process. Consequently, dumping or discharging the bulk material from the hopper car is often slowed down by the limited ability to move the material away from the hopper as it is discharged. Several different types of unloading systems have been developed to solve the problems of unloading such hopper type cars.

One type of unloading system uses a bridge disposed over a large hole. In this system, the hopper car can be driven onto the bridge and the material can be discharged while the hopper is over the hole. The bulk material can fall through holes in the bridge into the hole below. One advantage of this type of system is that the unloading time of the hopper car is only limited by how fast the bulk material can fall through the hopper gates. However, this unloading system requires significant and expensive excavation which results in extensive down time and loss of productivity of the transport vehicle thoroughfare and the unloading station during installation. Additionally, ground water contamination, environmental permits, and expense of finding bypass transport facilities during installation are also problems for these systems.

Other unloading systems use mobile conveyor belts that can be positioned underneath the hopper car between the hopper gates and the ground. These conveyors capture the bulk material as it falls from the hopper and transport the bulk material from under the hopper car. These mobile conveyor systems don't require expensive and lengthy excavation; however, they take longer to offload the bulk material because the conveyor belt can only transport the amount of bulk material that will fit between the bottom of the hopper gate and the top of the conveyor belt.

Another kind of unloading system lifts and tilts the hopper to dump the bulk material out of the top of the hopper. While the discharge time for these systems is comparable to the pit systems, large complex equipment is needed to lift and tilt the hopper car. Additionally, time is lost in securing and prepping the hopper car for the lift and tilt operation.

Still another type of unloading system couples large pipes to the hopper and forces the bulk material contents from the hopper with suction and/or pressurized air. Such pneumatic unloaders are not as fast as gravity drop systems and have complicated hook ups that take additional time to connect.

In addition to the problems noted, all of the unloading systems described above require assembly of individual components at the site of installation. This on-site construction further increases down time of the transport thoroughfare and also requires additional resources to complete the construction at the installation site.

### SUMMARY OF THE INVENTION

It has been recognized that it would be advantageous to develop a method and device for rapidly unloading a hopper type bulk material transport that minimizes excavation and downtime of transport facilities during installation. In addition, it has been recognized that it would be advantageous to develop a method and device to rapidly unloading a hopper type bulk material transport that provides for access to facilitate servicing and preventive maintenance. Additionally, it has been recognized that it would be advantageous to develop a bulk material unloading station formed as an integral, single unit for quick installation and configured to rapidly receive and transfer the contents of a bulk material transport vehicle.

The present invention provides a bulk material unloading station configured to rapidly receive and transfer the contents of a bulk material transport vehicle. The unloading station can include an unloading platform that can be alignable with an existing thoroughfare at an approximate ground level. A frame can disposed about the unloading platform, and can define a material flow control space for controlling the containment and flow rate of material unloaded from the bulk material transport vehicle. The material flow control space can have an upper containment portion that can be disposed above the unloading platform. The upper containment portion can contain an overflow of bulk material as the bulk material is unloaded on the unloading station. The material flow regulation space can also have a lower material flow regulation space disposed below the unloading platform. The material flow regulation space can control the flow rate of bulk material unloading onto the unloading platform and can minimize the transference of horizontal or shear forces from a lower portion of material to an upper portion of material. A conveyor system can be operably associated with the lower material flow regulation space, and can operate to horizontally move a lower portion of the bulk material.

The present invention also provides for a method for unloading the bulk material contents of a bulk material transport vehicle including aligning an unloading platform with an existing transport vehicle thoroughfare. A bulk material transport vehicle can be positioned on the unloading platform. The contents of the bulk material transport vehicle can be released so that a lower part of the contents fall into a hopper of the unloading station while a residual part of the bulk material remains in the transport vehicle. A conveyor system having a plurality of conveyor belts can be engaged to remove the lower portion of the bulk material contents from the hopper so the hopper can receive additional bulk material from the transport vehicle above.

Additionally, the present invention also provides for a method for servicing a bulk material unloading station including engaging a plurality of jacks to raise the unloading station from a shallow underground position and expose a material flow regulation space and material transfer space, including a conveyor. The material flow regulation space and conveyor can be serviced with the unloading station in the raised position. The plurality of jacks can be lowered to lower the unloading station into a shallow underground position with a top surface of an unloading platform aligned and coplanar with an existing transport vehicle thoroughfare.

The present invention also provides for a method for installing a bulk material unloading station including removing a section of a transport vehicle thoroughfare, such as a rail line or roadway. A relatively shallow excavation or hole less than approximately 6 feet can be excavated in the removed section of the thoroughfare. An unloading station having an integrated hopper and material transfer space can be placed in the excavation. The hopper can include a material storage space and a material flow regulation space. A top surface of an unloading platform in the hopper can be aligned with remaining existing sections of the thoroughfare so a bulk material transport vehicle can smoothly move from the thoroughfare to the unloading station.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a front view of a bulk material unloading station in accordance with an embodiment of the present invention, shown with a bulk material transport vehicle on an unloading platform;

FIG. 2 is a front view of the unloading station of FIG. 1, shown in without the transport vehicle;

FIG. 3 is cross section front view of the unloading station of FIG. 1;

FIG. 4 is a side view of the unloading station of FIG. 1;

FIG. 5 is a cross section side view of the unloading station of FIG. 1;

FIG. 6 is a top view of the unloading station of FIG. 1;

FIG. 7 is a bottom view of the unloading station of FIG. 1;

FIG. 8 is a cross section view of a transport vehicle positioned on the unloading station of FIG. 1;

FIG. 9 is a top cross section view of a conveyor system of the unloading station of FIG. 1;

FIG. 10 is a cross section side view of a conveyor system of the unloading station of FIG. 1;

FIG. 11 is a partial cross section side view of the conveyor system of FIG. 8; and

FIGS. 12a-12d illustrate a method for unloading a bulk material transport vehicle on the unloading station of FIG. 1 in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein generally provide for an unloading station for unloading bulk material from belly-dump, hopper style, bulk material, transport vehicle such as a railcar, semi tractor-trailer, or the like. The unloading station can be formed as an integrated, single unit that can be transported and installed without additional fabrication to the unloading station at the installation site. The unloading station can be installed and positioned in-line with an existing transport vehicle thoroughfare, such as an existing rail line or roadway. The unloading station can also be partially positioned below the grade of the existing thoroughfare in a relatively shallow below-ground, or below grade, excavation or hole. The excavation can be sufficiently deep to house or contain the unloading station yet sufficiently shallow so as to not require lateral supporting structure on the walls of the excavation.

Thus, in one aspect the excavation can have a depth of less than approximately 6 feet. The unloading station can have a hopper with a material storage space disposed substantially above ground, a material flow regulation space disposed at least partially below ground, and an unloading platform disposed substantially between the material storage space and the material flow regulation space. The unloading station can also have a material transfer space disposed below the ground level under the hopper. The material transfer space can include a conveyor system to transport material away from the unloading station. Together, the hopper and the material transfer space, including the conveyor system, can be formed as an integrated, single structure that is transportable as a single unit and that can be quickly installed into an existing transport vehicle thoroughfare.

In use, a transport vehicle can be positioned on the unloading platform and bulk material in the transport vehicle can be released into the hopper of the unloading station. A lower portion of material dumped from the transport vehicle can gravity feed into and through the material flow regulation space to the conveyor system in the material transfer space. The conveyor system can move the lower portion of bulk material while an upper portion of bulk material remains in and above the material flow regulation space. The conveyor system can move the lower portion of bulk material horizontally parallel to a longitudinal axis of the transport vehicle toward a location below the center of the transport vehicle. The conveyor system can also move the bulk material horizontally and transversely from the location below the center of the transport vehicle a location away from the transport vehicle.

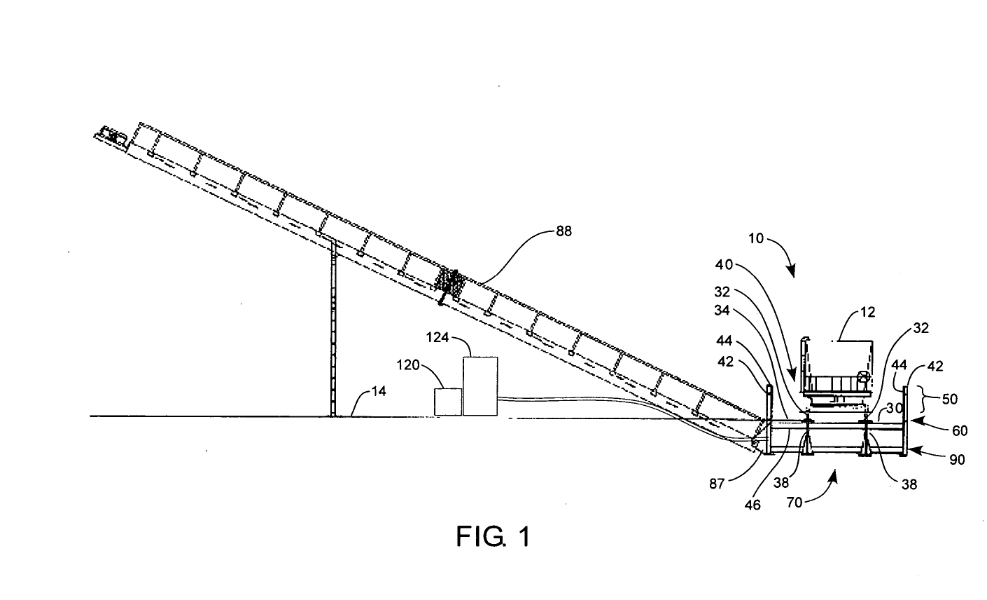

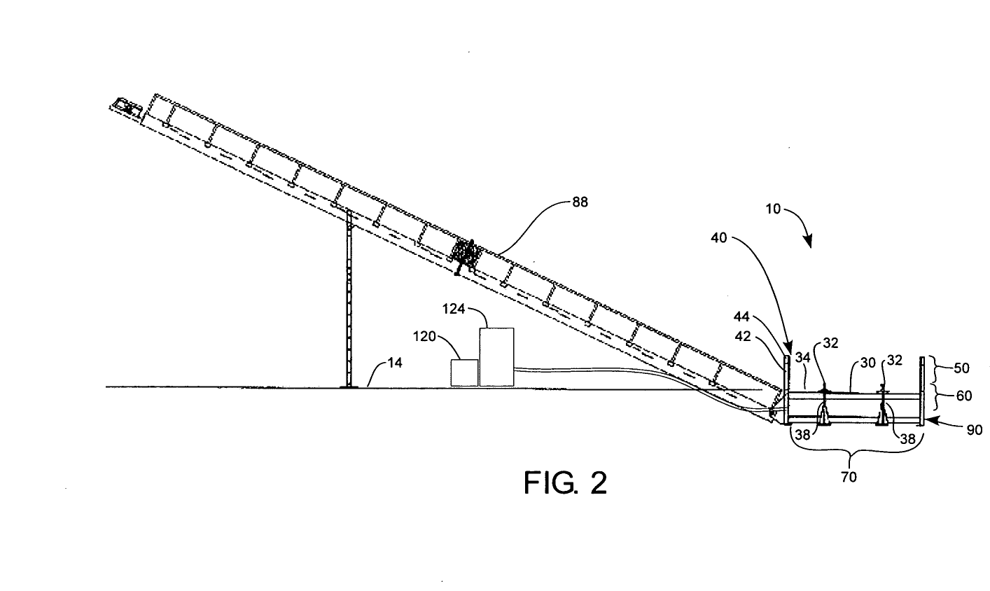

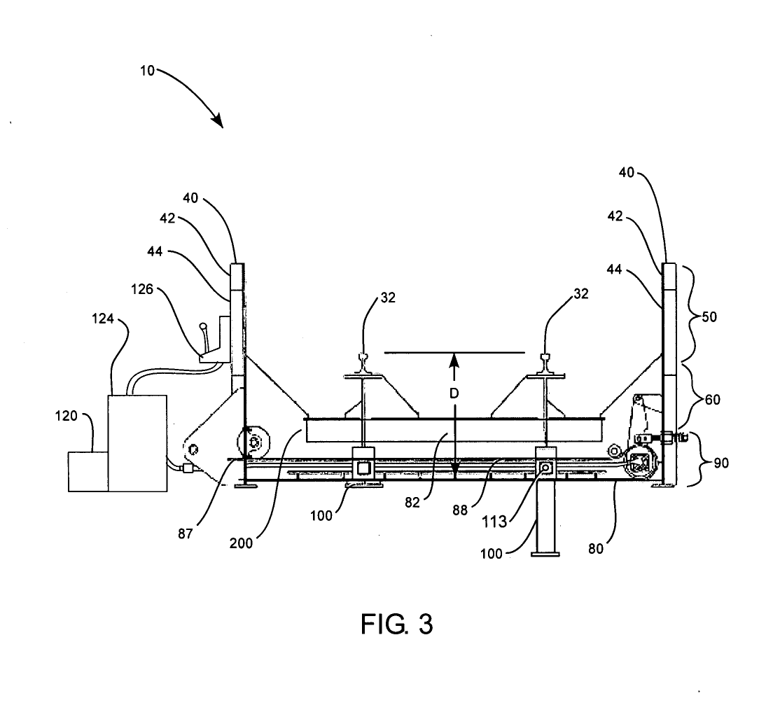

As illustrated in FIGS. 1-7, a bulk material unloading station, indicated generally at 10, in accordance with an embodiment of the present invention is shown for use in rapidly unloading and transferring the contents of a bulk material transport vehicle 12, such as a belly-dump, hopper style railcar, truck, trailer, semi-trailer or the like. The unloading station 10 can include a hopper, indicated generally at 40. The hopper 40 can include a material storage space, indicated generally at 50 (FIG. 3), disposed above the ground level 14, a material flow regulation space, indicated generally at 60, disposed at least partially below the ground level, and an unloading platform 30 disposed substantially between the material storage space and the material flow regulation space. The unloading station can also include a material transfer space, indicated generally at 90, disposed below the ground level 14 and under the hopper 40.

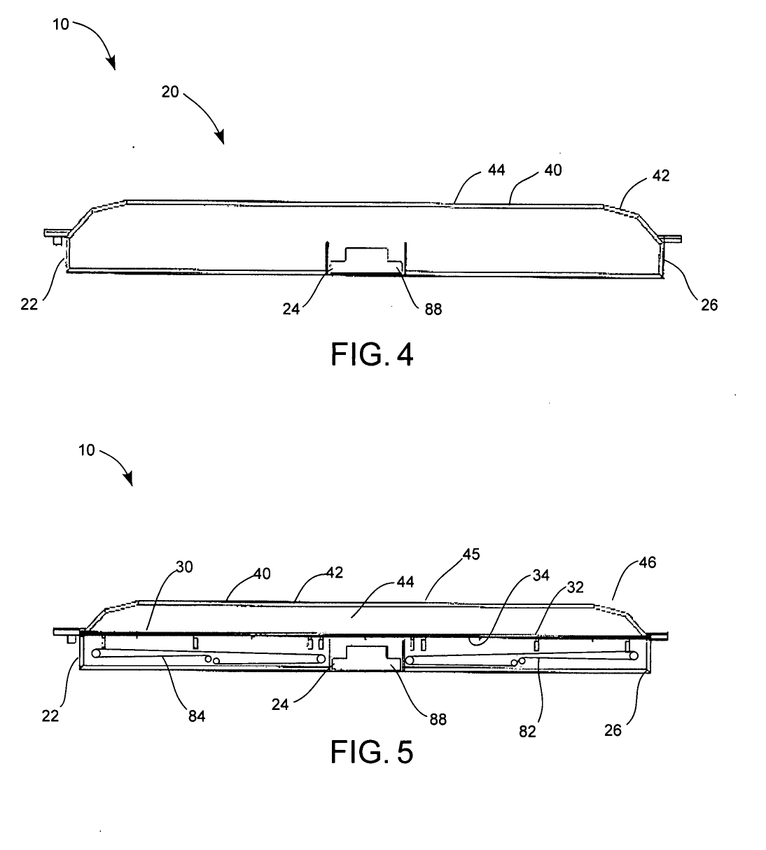

The material storage space 50 (FIG. 3) can be defined by an upper portion 42 of the hopper 40. The upper portion 42 can be substantially above ground level and also substantially above the unloading platform 30. The upper portion 42 can extend longitudinally along each side of the station 10 and can have sidewalls 44 (FIGS. 4 & 5) that can extend above the ground level. The sidewalls 44 can be sized and shaped to contain overflow dust and particles of bulk material, and to keep the bulk material within the unloading station 10 as the bulk material is unloaded or dumped from the transport vehicle 12.

It will be appreciated that many bulk materials, such as sand, gravel, dirt, and the like are aggregate in nature and have particles of varying size and shape. As these bulk or aggregate materials are unloaded or dumped from a transport vehicle, the smaller particles can be expelled away from the sides of the transport vehicle by the force of the bulk material dropping from the transport vehicle hopper. Thus, the side walls 44 of the material storage space 50 can help to reduce the expulsion of bulk material from the site of the unloading station 10, and can contain bulk material dust and other small particles within the confines of the unloading station 10. Advantageously, containing the bulk material during unloading provides a more efficient transfer since less bulk material is lost from the load carried by the transport vehicle. Additionally, less clean up is required after unloading a transport vehicle since most of the bulk material is contained within the unloading station.

The material storage space 50 can be fabricated from metal beams and metal sheeting that can be fastened or welded together to form the sidewalls 44. The sidewalls 44 can be coupled together by transverse members 46. The transverse members 46 can span the lateral width of the unloading station 10 and can provide support structure for the unloading platform 30. The transverse members 46 can be supporting structural members, as commonly used and known in the art, such as metal beams, tubing, or the like.

The a material flow regulation space 60 can be disposed at least partially below the ground level and under the material storage space 50. The material flow regulation space 60 can regulate the flow rate of the bulk material moving out of the material storage space 50 and the transport vehicle 12. The material flow regulation space 60 can also minimize the transference of momentum related forces within the bulk material during the unloading process as the bulk material is moved by the unloading station 10.

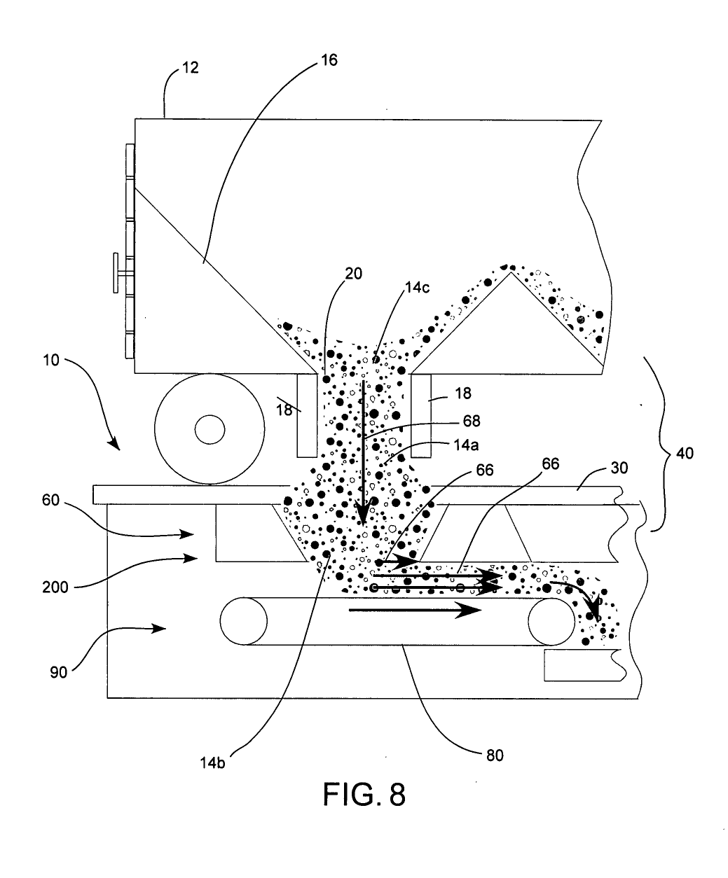

For example, as illustrated in FIG. 8, the material flow regulation space 60 can minimize the transference of horizontal, momentum related forces, indicated as arrows 66, from a lower, unloaded portion 14b of bulk material to an upper portion 14c of bulk material remaining in the material storage space 50. The lower portion 14b of bulk material 14a can be the portion of bulk material that gravity feeds first from the hopper 16 of the transport vehicle 12, through the unloading platform 30, and into the hopper 40 of the unloading station 10. The upper portion 14c of bulk material 14a can be the portion of bulk material above or on top of the first or lower portion 14b to fall through the platform 30. The upper portion 14c can remain partially contained within the hopper 16 of the transport vehicle 12, while the lower portion 14b is moved by the material transfer space 90. Thus, the material flow regulation space 60 can restrict horizontal momentum related forces in portions 14c of the bulk material remaining in the transport vehicle 12 and near the transport vehicle hopper gates 18 so that only vertical gravity related forces, indicated by arrow 68, can significantly act on the remaining bulk material in the transport vehicle 12.

In one aspect, the material flow regulation space 60 can have a deflection grating or baffle system, indicated generally at 200, that can have a plurality of through holes with inclined walls so that as material moves out of the transport vehicle 12 and into the baffles, the sloped or inclined walls can reduce the velocity of bulk material as the bulk material falls by the force of gravity 68 from the transport vehicle 12. The sloped walls can also direct the flow of the bulk material to a conveyor system 80 in the material transfer space 90.

Additionally, the size of the apertures can vary along the longitudinal length of the baffle system 200 in order to regulate the longitudinal flow rate from the transport vehicle 12 to the conveyor system 80 as described in greater detail in related U.S. Provisional Patent Application No. 60/810,290, filed on Jun. 2, 2006, which is herein incorporated by reference in its entirety for all purposes. In this way, the material flow regulation space 50 can provide a relatively even flow of material from the transport vehicle along the longitudinal length of the transport vehicle. Advantageously, controlling the longitudinal flow rate in this manner can minimize the transfer of horizontal momentum related forces on material remaining in the material storage area 50 and the transport vehicle 12.

It will be appreciated that since the bulk material 14a is dumped by the belly dump of the transport vehicle hopper 16 into a pile, any attempted movement of the lower portion 14b of the bulk material will also attempt to move the upper portion 14c of the bulk material. Rapid movement of the upper portion 14c remaining in the hopper 16 of the transport vehicle 12 can apply shear forces against the hopper 16 of the transport vehicle 12 and the gates 18 to the belly dump opening 20. These shear forces can damage the hopper 16 or gates 18.

Advantageously, as discussed above, the material flow regulation space 60 controls both the flow rate of bulk material from the transport vehicle hopper 16 as well as the transference of horizontal momentum related forces from the lower portion 14b of the pile of bulk material 14a to the upper portion 14c. Thus, the baffle system 200 can absorb or nullify horizontal movement related forces from the lower portion 14b of the pile by restricting horizontal movement of bulk material in and above the baffle. In this way, shear forces from the movement of the bulk material against the transport car hopper 16 and belly-dump gates 18 can be minimized so as to protect the gates from damage.

Returning to FIGS. 1-7, the bulk material unloading station 10 can include an unloading platform 30 disposed in the hopper 40 substantially between the material storage space 50 and the material flow regulation space 60. The unloading platform 30 can be positioned at approximately ground level 14, and can function as a bridge extending over the below ground portions of the unloading station 10. The unloading platform 30 can be alignable with an existing transport vehicle thoroughfare, such as a rail line or roadway so as to allow a transport vehicle traveling on the thoroughfare to move easily onto and off of the unloading platform.

The unloading platform 30 can include a pair of rails 32 or wheel tracks (not shown) in the case the transport vehicle 10 is a semi tractor trailer. The pair of rails 32 or wheel tracks can be coupled to a pair of metal beams 38, such as W sections or I beams. In one aspect, each metal beam 38 can be disposed under one of the rails 32 and can extend longitudinally in the direction of an existing rail line or roadway. The metal beams 38 can be sized and shaped to wholly support a loaded transport vehicle. In the case, I-beams are used reinforcing flanges can be coupled to the I-beam to provide structural support for the weight of the transport vehicle.

The unloading platform 30 can also have an open floor 34, or can have a plurality of apertures 36 through the platform 30 that bulk material can pass through when unloaded or dumped from the transport vehicle 12.

The unloading platform 30 can also be raisable between a raised position and an in-line position. In the raised position, workers and maintenance personnel can have access to the underground portions of the unloading station 10. In the in-line position, the rails 32 or wheel tracks of the unloading platform can be aligned with the rails or roadway of an existing transport vehicle thoroughfare.

The unloading station 10 can also have a material transfer space 90 disposed below the ground level 14 under the hopper 40. The material transfer space 90 can receive bulk material from the material flow regulation space 60 through the baffle or deflector grating 200. The material transfer space can have a conveyor system, indicated generally at 80, to horizontally move bulk material received from the material flow regulation space 60.

The conveyor system 80 can be a system of conveyor belts that can operate to horizontally move the lower portion 14b of the bulk material pile 14a dumped from the transport vehicle 12. The conveyor system 80 can include at least one conveyor belt 82 running longitudinally from a first end 22 of the unloading platform 30 toward a central portion 24 of the unloading platform, and at least one conveyor belt 84 running longitudinally from adjacent a second end 26 of the unloading platform 30 toward a central portion of the unloading platform. In this way, the bulk material dumped from the hopper 16 of the transport vehicle 12 into the unloading station 10 can be moved to a central collection point under the transport vehicle.

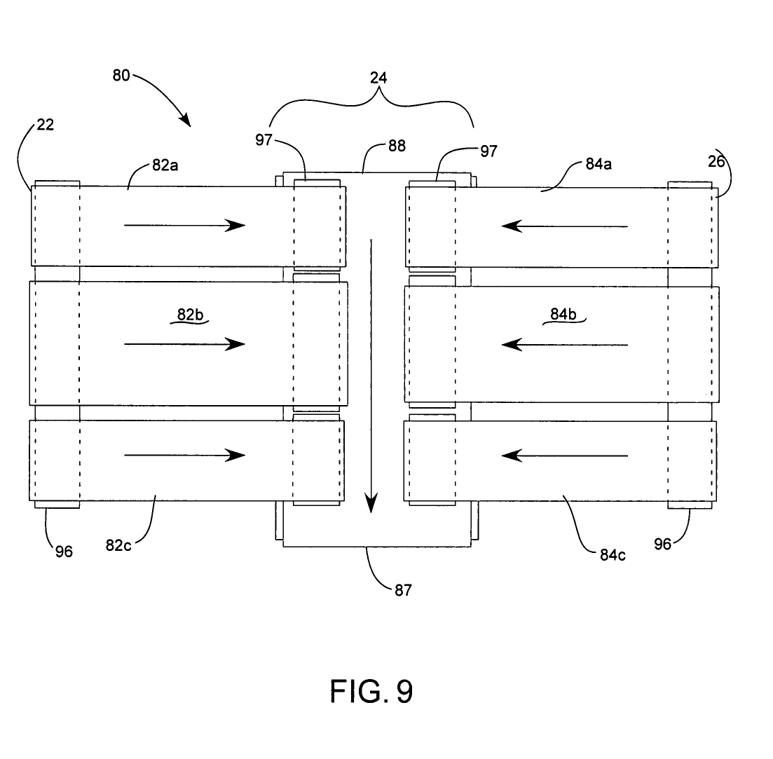

In one aspect, the conveyor system 80 can include three longitudinal belts 82a, 82b, and 82c extending from the first end 22 to the central portion 24 of the unloading station, and three corresponding belts 84a, 84b, and 84c running from the second end 26 to the central portion, as shown in FIG. 9. In the case where the conveyor system 80 has three longitudinal belts, the three belts can be aligned side by side, parallel to one another, to substantially cover or cross the lateral width of the unloading station 10. In this way, the conveyor system 80 can maximize the capture and transfer of bulk material falling from the material flow regulation space 60.

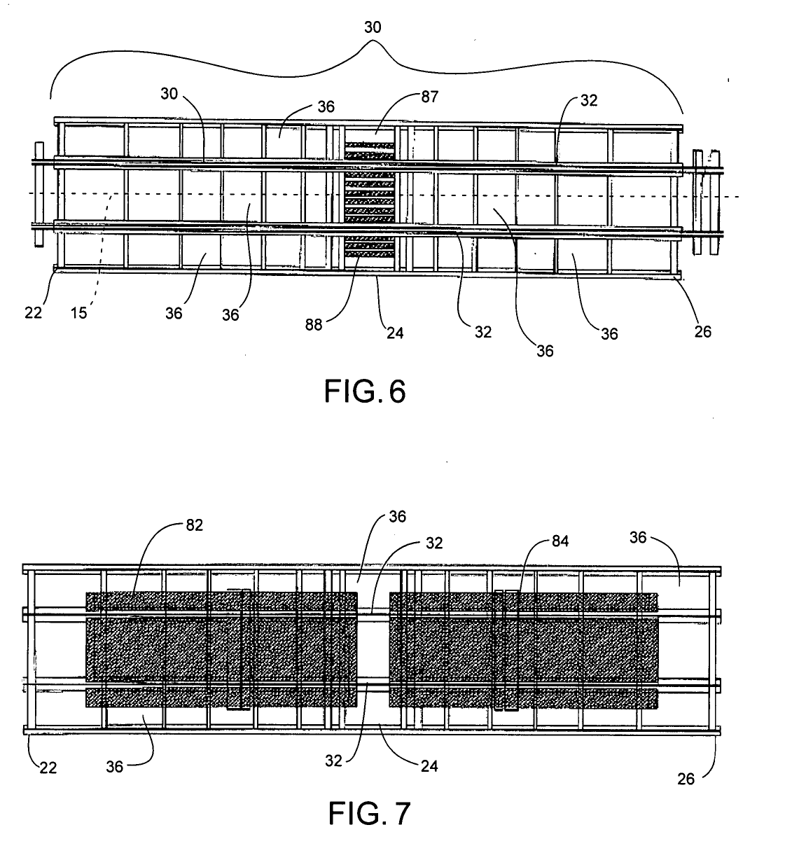

Referring to FIGS. 6-7 and 9, a transverse conveyor belt 86 can be disposed under the central portion 24 of the bridge and under the two longitudinal conveyor belts 82 and 84. The transverse conveyor belt 86 can run transverse to the longitudinal axis, indicated by dashed line at 15, of the transport vehicle and can extend across the bridge 20. In one aspect, the transverse conveyor can extend uphill and away from the unloading station in order to move material from below the unloading station to an above ground access point. For example, the transverse conveyor can be a 60 foot continuous belt with a portion below the unloading station 10 and a distal end away from the unloading station. In another aspect, an uphill conveyor belt 88 can be associated with the end 87 of the transverse conveyor belt 86 and can receive material from the transverse conveyor belt 86. The uphill conveyor belt 88 can transport the bulk material up and out of the below ground portions of unloading station 10.

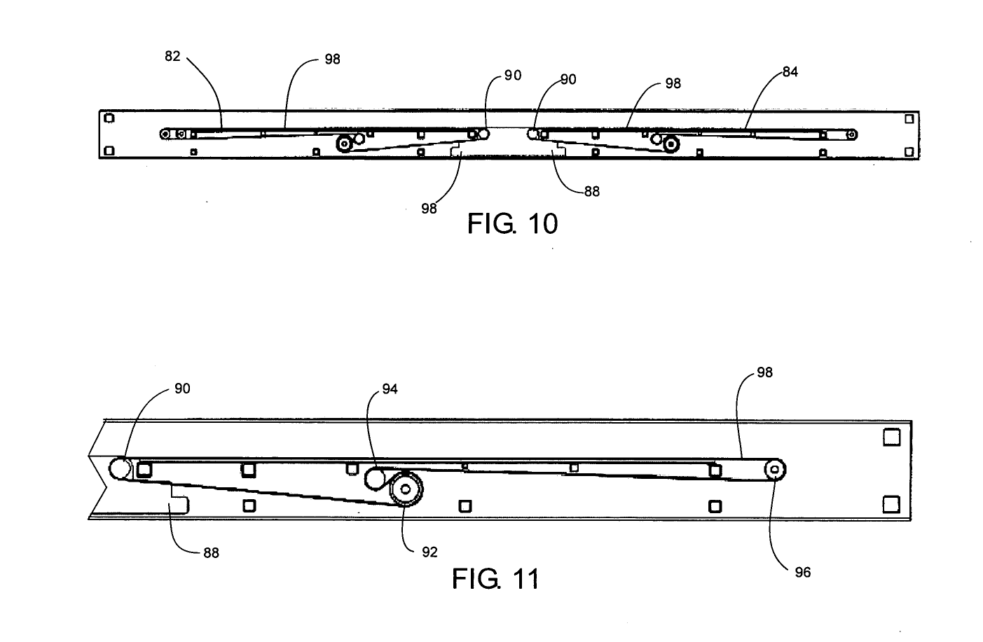

Referring to FIGS. 10-11, the conveyor belts of the conveyor system 80 described above can be continuous belts 98 disposed around a plurality of wheels. The plurality of wheels can include a head wheel 90 disposed at a head end of the continuous belt. The head wheel 90 can tension and direct the motion, or track, of the continuous belt. The plurality of wheels can also include a drive wheel 92 disposed at a central portion of the conveyor. The drive wheel 92 can engage and turn the continuous belt to convey the contents of the hopper car. The continuous belt 98 of the conveyors can form an S-curve around the drive wheel 92 and an idler wheel 94 disposed adjacent the drive wheel. A second idler wheel 96 can stretch and tension the continuous belt 98.

Advantageously, the S-curve, or serpentine configuration of the continuous belt 98 can minimize the vertical height of the conveyor and, thus, can decrease the size of the hole below ground necessary to house the underground portion of the unloading station 10. Additionally, the S-curve more evenly distributes load from the drive wheel throughout the continuous belt and tensions the belt against the weight of the bulk material.

In the case of three longitudinal belts described above, the conveyor system 80 can include a plurality of head wheels 97, as shown in FIG. 9. Each head wheel 97 can be disposed in one of the continuous belts 82a, 82b, 82c, 84a, 84b, or 84c, and each head wheel 97 can independently tension and direct the motion of the continuous belt in which the head wheel is disposed. A common tail wheel 96 can be disposed through all of the plurality of continuous belts. The common tail wheel, or idler wheel 96, can tension all of the belts at a common end.

Returning to FIGS. 1 and 6, a power supply station can supply power to the conveyor system. For example, the power supply station can have diesel motor 120 coupled to hydraulic pumps 122. The hydraulic pumps can supply pressurized hydraulic fluid to hydraulic motors 124 coupled to the drive wheels of the continuous belts in the conveyor system 80. Other types of power supplies, such as electric motors, pneumatic compressors, and the like, can also be used to power the unloading station, as known in the art. Additionally, a controller 126 can be coupled to the power supply and motors so that the entire unloading station 10 can be operated by a single user.

Together the hopper 40 and the material transfer space 90 can form the unloading station 10 as an integrated structure that is transportable and installable as a single unit. Advantageously, the integrated structure of the unloading station 10 can be relatively compact, thereby reducing the distance, indicated as D in FIG. 3, between the uppermost surface of the wheel paths 38 and a lowermost surface of the material transfer space 90. For example, the unloading station can have a distance D of less than approximately 50 inches. In this way, the total height of a corresponding excavation below the grade of the thoroughfare can be minimized, thereby reducing construction and installation time.

Additionally, the integrated structure of the unloading station 10 can facilitate quick installation into an existing transport vehicle thoroughfare. In this way, the bulk material unloading station 10 can be an integrated, modular unit that can be fabricated and shipped as a complete or single unit to the location the station 10 will be inserted into an existing rail line or roadway.

It is a particular advantage of the present invention that the unloading station 10 can be fabricated as an integrated structure and transported as a single unit. It will be appreciated that such a fabrication process speeds up the installation time of the device since additional fabrication need not be performed at the installation site. In contrast, other unloading stations are often assembled at the site of installation and require significant down time of the rail line or roadway. Thus, the unloading station of the present invention provides significant savings with respect to excavation, construction, fabrication, and down-time of existing facilities.

As noted above, the unloading station 10 can be at least partially contained within a hole or excavation in the ground, or below the grade of an existing transport vehicle thoroughfare, such as a rail line or roadway. Specifically, the bulk material unloading station 10 can be positioned in an excavation 70 with a total below ground depth less than approximately the combined height of the material flow regulation space 60 and the material transfer space 90. In one aspect, the below grade or below ground portion of the unloading station 10 can have a depth of less than approximately 72 inches. In another aspect, the below grade portion of the station can have a depth of less than approximately 50 inches. In yet another aspect, the total below grade portion of the station can have a depth of 42 and ⅝ inches where the grade is measured from the transport vehicle thoroughfare, rail line, or roadway.

It is another particular advantage of the present invention that the total below grade or below ground portion of the unloading station 10 is relatively shallow. Because the bulk material unloading station 10 has such a shallow below ground depth, the unloading station 10 can be positioned in line with an existing thoroughfare with a total below ground depth sufficiently shallow so as to not require lateral supports in the corresponding excavation. It will be appreciated that typical gravity feed dump stations require a total depth sufficient to contain an entire transfer vehicle load. In some cases these holes must be up to 20 feet deep or more. While this type of system enables quick unloading times, these dump stations also require significant and expensive excavation and support structure to maintain the walls of the excavation. Unfortunately, such large excavations and construction of the corresponding support structure usually result in lengthy down time for an existing rail line or roadway. In contrast, the unloading station 10 of the present invention only requires a relatively shallow excavation and correspondingly short installation time since such a shallow excavation does not require any additional construction to laterally support the walls of the excavation.

Another advantage of using a shallow excavation with the unloading station of the present invention is that the width of the excavation can also be smaller than a typical below ground unloading station. It will be appreciated that a conveyor moving bulk material from a below ground excavation to an above ground deposit point must have an incline angle sufficiently shallow so as to prevent bulk material from sliding off or back down the conveyor. Consequently, the length of the below ground portion of the conveyor must be sufficiently long so as to accommodate the required angle. Thus, the excavation must be large enough to accommodate the below ground length of the conveyor. In contrast, the shallow depth of the unloading station of the present invention allows the conveyor to rise from the below ground portion immediately adjacent the unloading station, and excavation along the sides of the unloading station can thus be minimized, or in some instances may not be required at all. Thus, the unloading station of the present invention reduces the depth and width of excavation needed, thereby reducing down time of the transport vehicle thoroughfare during installation.

In use, a transport vehicle 12 can be moved onto the unloading station 30 with the hopper 16 of the transport vehicle positioned over the unloading platform. The hopper gates 20 on the transport vehicle hopper 16 can then be opened and the contents of the transport hopper 16 can fall from through the unloading platform 30 and into the material flow regulation space 60. The material flow regulation space 60 can slow the fall of the bulk material and can direct the bulk material onto the longitudinal conveyor belts 82 and 84 below the material flow regulation space. The longitudinal conveyor belts 82 and 84 can be engaged to horizontally move the lower portion 14b of the bulk material 14a parallel to the longitudinal axis 15 of the transport vehicle 12 to a central region under the vehicle. The bulk material can then fall from the longitudinal belts 82 and 84 onto the transverse belt 86 and the transverse belt can move the bulk material out from under the transport vehicle 12. Thus, the hopper 40 can receive the lower portion 14b of the contents of the bulk material transport vehicle 12 and direct the lower portion 14b of the bulk material pile 14a to the conveyor system 80 that can remove the lower portion 14b of the bulk material pile from the hopper 40 so the hopper 40 can receive additional bulk material from the upper portion 14c of the bulk material pile 14a. Thus, the hopper 40 and the conveyor system 80 can operate together to continuously empty, or drain, the contents of the bulk material transport vehicle 12.

In this way, the unloading station 10 of the present invention can rapidly empty and remove the contents of the hopper 16 of a transport vehicle 12. For example, in one aspect, the flow rate for transferring material from the transport vehicle can be approximately 1 ton per second, or approximately 100 tons per 100 seconds. Thus, the entire contents of the transport vehicle can be rapidly removed by the unloading station 10 of the present invention.

Returning to FIG. 3, the unloading station can also have a plurality of jacks 100 extending from the metal beams 38 to a ground or support surface in the hole. The plurality of jacks 100 can raise the unloading station 10 to allow access for maintenance personnel in the material flow regulation space and to the conveyor system. In one aspect the unloading station 10 can have a jack 100 on each end of each of the pair of metal beams 38 for a total of 4 jacks. The jacks 100 can raise the unloading station 10 up to a height greater than approximately 24 inches. It will be appreciated that the jacks 100 can be raised by common power sources known in the art, such as hydraulic, pneumatic, or electric motors and cylinders. The jacks 100 can also lower and align the rails 32 or roadway with the existing rail lines or roadway to ensure a smooth transition from the existing transport vehicle thoroughfare to the unloading station 10. The jacks can be locked into a position by a lock pin 113 or other locking devices as known in the art. The jacks can be powered by the power supply and operated by the controller 126 described above.

In another aspect, the unloading station 10 can have a pair of lifting jacks 100 and a pair of safety locking jacks (not shown). The lifting jacks can lift the unloading station as described above, and the locking jacks can extend from the lifted unloading station to a ground surface. The locking jacks can be locked in the extended position to prevent the unloading station from lowering back into the excavation. Such locking jacks can be advantageous when using hydraulic lifting jacks because the hydraulic system can be turned off for servicing when the unloading station is in the lifted position. Thus, the locking jacks can maintain the unloading station in the lifted position even when the hydraulic system and hydraulic jacks are turned off.

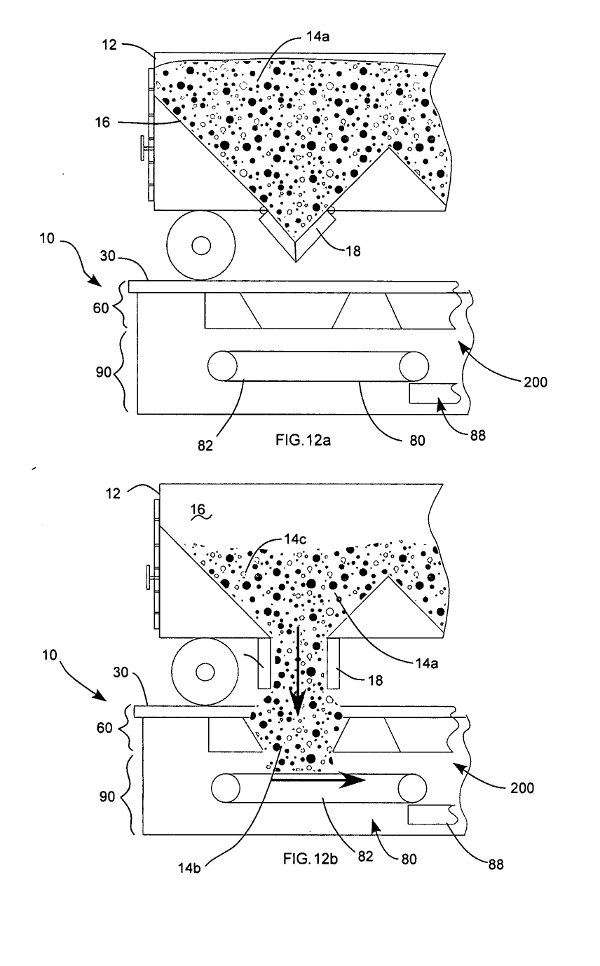

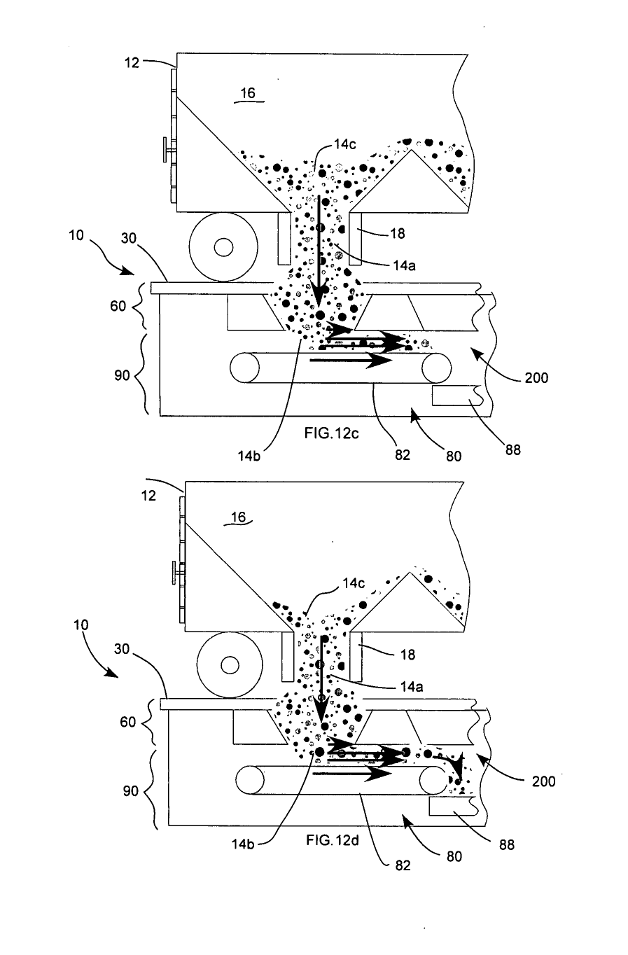

As illustrated in FIGS. 12a-d, the present invention also provides for a method for unloading the bulk material contents 14 of a bulk material transport vehicle 12 including aligning an unloading platform 30 with an existing transport vehicle thoroughfare 1 10. A bulk material transport vehicle 12 can be positioned on the unloading platform 30, as shown in FIG. 12a. The contents 14 of the bulk material transport vehicle 12 can be released so that a lower part 14b of the contents fall into a hopper 40 of the unloading station 10 while a residual part of the bulk material remains in the transport vehicle, as shown in FIG. 1 2b. A conveyor system having a plurality of conveyor belts can be engaged to remove the lower portion of the bulk material contents from the hopper so the hopper can receive additional bulk material from the transport vehicle above, as shown in FIGS. 12c-12d.

Additionally, the present invention also provides for a method for servicing a bulk material unloading station including engaging a plurality of jacks to raise the unloading station from a shallow underground position and expose a material flow regulation space and material transfer space, including a conveyor. The material flow regulation space and conveyor can be serviced with the unloading station in the raised position. The plurality of jacks can be lowered to lower the unloading station into a shallow underground position with a top surface of an unloading platform aligned and coplanar with an existing transport vehicle thoroughfare.

The step of engaging the jacks can include actuating a power supply and power transfer system such as hydraulic actuators and pumps, pneumatic compressors, electric motors, and the like.

The present invention also provides for a method for installing a bulk material unloading station including removing a section of a transport vehicle thoroughfare, such as a rail line or roadway. A relatively shallow excavation or hole less than approximately 6 feet can be excavated in the removed section of the thoroughfare. An unloading station having an integrated hopper and material transfer space can be placed in the excavation. The hopper can include a material storage space and a material flow regulation space. A top surface of an unloading platform in the hopper can be aligned with remaining existing sections of the thoroughfare so a bulk material transport vehicle can smoothly move from the thoroughfare to the unloading station.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A bulk material unloading station configured to rapidly receive and transfer the contents of a bulk material transport vehicle, comprising:
a) a hopper disposed at least partially below a ground level and configured to contain and transfer unloaded bulk material, the hopper further comprising:
i) a material storage space disposed above the ground level, and configured to contain bulk material dumped from the transport vehicle;
ii) a material flow regulation space disposed at least partially below the ground level under the material storage space, and configured to regulate the flow of the bulk material moving out of the material storage space; and
iii) an unloading platform disposed in the hopper substantially between the material storage space and the material flow regulation space at approximately ground level; and
b) a material transfer space disposed below the ground level under the hopper, configured to receive bulk material from the material flow regulation space, and having a conveyor system operable to horizontally move bulk material received from the material flow regulation space;
c) the hopper and the material transfer space together forming an integrated structure transportable as a single unit, and configured for quick installation into an existing transport vehicle thoroughfare.

2. The station of claim 1, wherein the bulk material unloading station is configured for positioning with a total below ground depth less than approximately the combined height of the material flow regulation space and the material transfer space.

3. The station of claim 1, wherein the total below ground depth is less than approximately 72 inches.

4. The station of claim 1, wherein the bulk material unloading station is configured for positioning with a total below ground depth sufficiently shallow to allow a corresponding excavation.

5. The station of claim 1, wherein the material flow regulation space is configured to receive and regulate a flow of a part of the bulk material contents of the transport vehicle while a remaining part of the bulk material remains in the transport vehicle.

6. The station of claim 1, wherein the material transfer space is configured to receive bulk material from the material flow regulation space while a remaining part of the bulk material remains in the transport vehicle.

7. The station of claim 1, wherein the unloading platform is positionable in line with an existing transport vehicle thoroughfare.

8. The station of claim 7, wherein the transport vehicle is a railcar, and the unloading platform includes a pair of rails alignable with an existing rail line.

9. The station of claim 7, wherein the transport vehicle is truck, and the unloading platform includes a pair of tire tracks alignable with an existing roadway.

10. The station of claim 7, wherein the unloading platform further includes a pair metal beams, each metal beam being disposed under each of a pair of wheel paths to support the wheel paths, each metal beam extending a longitudinal length of the unloading station in the direction of an existing transport vehicle thoroughfare, and each beam sized and shaped to support a loaded transport vehicle thereon.

11. The station of claim 10, wherein the distance between the uppermost surface of the wheel paths and a lowermost surface of the material transfer space is less than approximately 50 inches.

12. The station of claim 1, wherein the hopper further includes a plurality of jacks disposed under the unloading platform, the plurality of jacks being configured to raise the unloading station to allow access to the material flow regulation space and the material transfer space.

13. The station of claim 12, wherein the hopper further includes a pair metal beams, each metal beam being disposed under the unloading platform and extending a longitudinal length of the unloading station, and the plurality of jacks are the pair of metal beams to raise the metal beams and the unloading platform to provide access to the material flow regulation space and the material transfer space.

14. The station of claim 13, wherein the plurality of jacks raise the unloading platform up to a height greater than approximately 24 inches.

15. The station of claim 12, wherein the plurality of jacks includes a locking mechanism configured to maintain the unloading platform in a raised position when in a locked configuration.

16. The station of claim 1, wherein the conveyor system further includes:
a) At least one conveyor running longitudinally from adjacent a first end of the unloading platform toward a central portion of the unloading platform;
b) At least one conveyor running longitudinally from adjacent a second end of the unloading platform toward a central portion of the unloading platform;
c) At least one conveyor disposed under the central portion of the unloading platform and running transverse the unloading platform from a first side to at least a second side of the unloading platform.

17. The station of claim 1, wherein the conveyor system further includes:
a) a continuous belt forming a conveyor configured to receive and move bulk material from the material flow regulation space;
b) a head wheel disposed inside the continuous belt at a first end of the conveyor, and configured to tension the continuous belt and direct the motion of the continuous belt;
c) a drive wheel disposed inside the continuous belt at a central portion of the conveyor, and configured to engage and turn the continuous belt to convey the bulk material; and
d) an idler wheel disposed inside the continuous belt adjacent the drive wheel with the continuous belt forming S-curve around the drive wheel and the idler wheel; and
e) a tail wheel disposed inside the continuous belt at a second end of the conveyor, and configured to tension the continuous belt.

18. The station of claim 17, wherein the conveyor system further includes:
a) a plurality of continuous belts, each configured to receive and move bulk material;
b) a plurality of head wheels, each head wheel disposed in one of the plurality of continuous belts and each head wheel configured to tension and direct the motion of the continuous belt in which the head wheel is disposed; and
c) a common tail wheel disposed inside each of the plurality of continuous belts, and configured to tension all of the plurality of belts at a common end of each of the plurality of belts.

19. A bulk material unloading station formed as an integral, single unit for quick installation and configured to rapidly receive and transfer the contents of a bulk material transport vehicle, comprising:
a) a hopper disposed at least partially below a ground level and above a material transfer space and configured to contain and transfer unloaded bulk material, the hopper further comprising:
i) a material storage space disposed above the ground level, and having a pair of side walls extending longitudinally along the hopper, the side walls configured to contain bulk material dumped from the transport vehicle;
ii) a material flow regulation space disposed at least partially below the ground level under the material storage space, and configured to receive bulk material from the material storage space and control the flow rate, direction and transfer forces of the bulk material moving out of the material storage space; and
iii) a raisable unloading platform disposed in the hopper at approximately ground level, and raisable to allow access to the material transfer space;
b) the material transfer space being disposed below the ground level under the hopper, configured to receive bulk material from the material flow regulation space, and having a conveyor system operable to horizontally move bulk material received from the material flow regulation space; and
c) the bulk material unloading station being configured for positioning with a total below ground depth less than approximately the combined height of the material flow regulation space and the material transfer space.

20. The station of claim 19, wherein the hopper, material transfer space, and the raisable unloading platform together form an integrated structure transportable as a single unit, and configured for quick installation into an existing transport vehicle thoroughfare, and the below ground depth does not require lateral supports on a corresponding excavation.

21. The station of claim 19, wherein the total below ground depth is less than approximately 72 inches.

22. A bulk material unloading station formed as an integral, single unit for quick installation and configured to rapidly receive and transfer the contents of a bulk material transport vehicle, comprising:
a) a hopper disposed at least partially below a ground level and above a material transport space and configured to contain and transfer unloaded bulk material, the hopper further comprising:
i) a material storage space disposed above the ground level, and configured to contain bulk material unloaded from the transport vehicle; and
ii) a material flow regulation space disposed at least partially below the ground level under the material storage space, and configured to receive and regulate a flow of a part of the bulk material contents of the transport vehicle while a remaining part of the bulk material remains in the transport vehicle; and
iii) a raisable unloading platform disposed in the hopper at approximately ground level, and raisable to allow access to the material transfer space; and
b) the material transfer space being disposed below the ground level under the hopper, and configured to receive bulk material from the material flow regulation space while a remaining part of the bulk material remains in the transport vehicle, and having a conveyor system operable to horizontally move bulk material received from the material flow regulation space.

23. A bulk material unloading station formed as an integral, single unit for quick installation and configured to rapidly receive and transfer the contents of a bulk material transport vehicle, comprising:
a) a hopper disposed at least partially below a ground level and configured to contain and transfer unloaded bulk material, the hopper further comprising:
i) a material storage space disposed above the ground level, and having a pair of side walls extending longitudinally along the hopper, the side walls configured to contain bulk material dumped from the transport vehicle;
ii) a material flow regulation space disposed at least partially below the ground level under the material storage space, and configured to receive bulk material from the material storage space and control the flow rate, direction and transfer forces of the bulk material moving out of the material storage space; and
iii) a raisable unloading platform disposed in the hopper at approximately ground level, and raisable to allow access to a material transfer space.
b) a material transfer space disposed below the ground level under the hopper, configured to receive bulk material from the material flow regulation space, and having a conveyor system operable to horizontally move bulk material received from the material flow regulation space; and
c) the bulk material unloading station being configured for positioning with a total below ground depth that does not require lateral supports on a corresponding excavation.

24. A method for servicing a bulk material unloading station, comprising:
a) engaging a plurality of hydraulic legs to raise the unloading station from a shallow underground excavation and expose a material flow regulation space and a material transfer space of the unloading station;
b) servicing equipment in the material flow regulation space and the material transfer space; and
c) lowering the plurality of hydraulic legs to lower the unloading station into the shallow underground excavation; and
d) aligning a top surface of an unloading platform to be substantially flush with an existing bulk material transport vehicle thoroughfare.

25. A method for installing a bulk material unloading station formed as an integrated, single unit for quick installation, comprising:
a) removing a section of an existing bulk material transport vehicle thoroughfare;
b) excavating a sufficiently shallow hole in the removed section of the thoroughfare to position the unloading station with a total below ground depth sufficiently shallow to not require lateral supports in the hole and less than six feet;
c) placing the integrated, single unit unloading station in the hole;
f) aligning a top surface of an unloading platform with at least one remaining portion of the existing transport vehicle thoroughfare to provide a substantially flush transition between the existing transport vehicle thoroughfare and the top surface of the unloading platform.

26. A method for unloading the contents of a bulk material transport vehicle on a bulk material unloading station formed as an integrated, single unit for quick installation, comprising:
a) aligning an unloading platform of the unloading station with an existing transport vehicle thoroughfare;
b) positioning a bulk material transport vehicle on the unloading platform;
c) releasing the contents of the bulk material transport vehicle so that a part of the bulk material contents of the transport vehicle fall into a hopper of the unloading station positioned at least partially below the unloading platform while a residual part of the bulk material remains in the transport vehicle; and
d) engaging a horizontal conveyor disposed below the hopper to remove the bulk material from the hopper without applying a substantially horizontal force to a lower portion of the transport vehicle so the hopper can receive additional bulk material from remaining bulk material in the transport vehicle.
